(19) United States
(12) Patent Application Publication
(10) Pub. No.: US 2006/0164025 A1
(43) Pub. Date: Jul. 27, 2006

(54) Lamp driving apparatus for vehicle

(75) Inventors: Akiyoshi Kanazawa, Susono-shi (JP); Kazuhira Kobayashi, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: YAZAKI CORPORATION

(21) Appl. No.: 10/602,887

(22) Filed: Jun. 25, 2003

(30) Foreign Application Priority Data
Jun. 25, 2002 (JP) P2002-185031

(51) Int. Cl. H05B 41/36

(52) U.S. Cl. 315/307

(57) ABSTRACT

A lamp driving apparatus includes a controller, a lamp driver, a lamp voltage detector, a switch and a switching controller. The controller outputs a switch control signal and a lamp driving control signal in response to an instructing signal for instructing a lamp to be turned on and off. The lamp driver supplies an electric power to the lamp in accordance with the lamp driving control signal. The lamp voltage detector detects a voltage applied to the lamp, and outputs a detecting signal showing the applied state of the voltage to the controller. The switch is connected to the lamp driver, a lamp driving power supply line, and a preliminary power supply line, and switches between a first state and a second state selectively. The first state is a state that the electric power for driving the lamp can be supplied to the lamp driver from the lamp driving power supply line The second state is a sate that the electric power for driving the lamp can be supplied to the lamp driver from the preliminary power supply line. The switching controller controls a switching of the switch in accordance with the switch control signal. The controller outputs the switch control signal so as to make the switch to the first state when the instructing signal for instructing the lamp to be turned on. The controller outputs the switch control signal so as to make the switch to the second state in a case that the detecting signal showing an abnormal applied state of the voltage is received from the lamp voltage detector while the controller outputs the lamp driving control signal for turning on the lump.

### BACKGROUND OF THE INVENTION

The present invention relates to a lamp driving apparatus for a vehicle which can be mounted on various kinds of vehicles including motor vehicles or the like, and more particularly to a lamp driving apparatus for a vehicle having a fail safe function.

A motor vehicle on which a power source part of rated DC 12 volt to 14 volt output having an alternator of 14 volt (it is referred to as “V”, hereinafter) and a 12 V battery capable of charging and discharging is mounted (that is, what is called a 14V vehicle) has been generally known as a usual motor vehicle. In this 14V vehicle, a lamp driving apparatus for a vehicle which receives an electric power from the power source part to drive various types of lamps such as a head lamp, a room lamp, etc. (that is, incandescent bulbs having filaments) applies the DC 12V to 14V to the lamps to turn on the respective lamps.

In recent years, a high voltage motor vehicle (that is, what is called a 42 V vehicle) advantageous in its fuel consumption on which a power source part of rated DC 36 V to 42V output having a 42V motor/generator and a 36V battery capable charging and discharging is mounted has been progressively developed. If a general purpose 14V type electric load (that is, an electrical device) used in the 14V vehicle can be used in the 42V vehicle in place of an expensive 42V type electric load (that is, an electrical device), this will be extremely advantageous in view of cost. Thus, a method has been studied that a DC voltage converter (that is, a DC/DC converter) for converting the output voltage such as the DC 36V to 42 V of the power source part into DC 14V is provided in the 42 V vehicle so that the 14 V type electric load can be driven by supplying an electric power from the DC voltage converter.

However, the DC voltage converter having a capability that while high voltage such as DC 36 V to 42 V is converted into low voltage such as DC 14V to drive several 14 V type electric loads, a heavy electric load such as a lamp for the 14 V vehicle can be further driven is extremely expensive and has problems in view of size, weight and heat generation, etc. Therefore, as for the lamp for the 14 V vehicle, a lamp driving apparatus for a vehicle has been currently studied in which pulse voltage is applied to the lamp by a PWM control (that is, a pulse width modulation control) to adjust electric energy supplied to the lamp so that the lamp for the 14 V vehicle can be driven in the 42 V vehicle. An example of such a lamp driving apparatus for a vehicle will be described by referring to FIGS. 8 and 9.

FIG. 8 is a view showing a circuit structure of a lamp driving apparatus 1 for a vehicle. As described above, the lamp driving apparatus 1 for a vehicle adjusts electric energy supplied to the lamp L1 by a PWM control. The lamp driving apparatus 1 includes a lamp driving part 3 which is supplied the electric power from a power source part 6 of rated DC 36V to 42 V through a lamp driving power supply line 4 for driving the lamp L1, and a control part 2 which controls the driving part 3. As described above, the power source part 6 has a 42 V motor/generator 7 and a 36V battery 8 capable of charging and discharging. Supply voltage Vb applied to the lamp driving power supply line 4 is DC 36V to DC 42V in accordance with the rated output voltage of the power source part 6.

The control part 2 is electrically connected to the lamp driving part 3. The control part 2 outputs a lamp driving control signal S11 in accordance with an instructing signal S1 showing the ON/OFF state of a switch SW1 for turning on and off the lamp L1. The control part 2 supplies the lamp driving control signal S11 to the lamp driving part 3 to control the operation of the lamp driving part 3. The lamp driving part 3 is electrically connected to the lamp driving power supply line 4 and a lamp driving line 5. The lamp driving part 3 applies or not applies voltage to the lamp L1 through the lamp driving line 5 in accordance with the lamp driving control signal S11 from the control part 2 so that the Lamp 1 is turned on and off. FIG. 9 is a timing chart showing the voltage wave-form of the instructing signal S1, the voltage wave-form of the lamp driving control signal S11 and the wave-form of lamp applied voltage VL applied to the lamp L1 by the lamp driving part 3.

As shown in FIG. 9, the control part 2 supplies the lamp driving control signal S11 to the lamp driving part 3 synchronously with a timing that the voltage wave-form of the instructing signal S1 is switched from a Low level to a High level to allow the lamp driving part 3 to apply the lamp applied voltage VL to the lamp L1 in accordance with the lamp driving control signal S11 and to turn on the lamp L1. The lamp driving control signal S11 has a pulse voltage wave-form that a High level and a Low level are alternately repeated. That is, when the control part 2 receives the instructing signal S1 for turning on the lamp L1, the control part 2 outputs the lamp driving control signal S11 to allow the lamp driving part 3 to supply an electric power to the lamp L1.

The lamp driving control signal S11 and the lamp applied voltage VL are respectively set a prescribed duty ratio of the pulse width of high level relative to one period when the lamp L1 is turned on so that proper electric power is supplied to the lamp L1. On the other hand, the control part 2 supplies the lamp driving control signal S11 having the voltage wave-form of low level to the lamp driving part 3 synchronously with a timing that the voltage wave-form of the instructing signal S1 is switched from the high level to the low level so that the lamp driving part 3 does not apply voltage to the lamp L1 in accordance with the lamp driving control signal S11 to turn off the lamp L1.

The lamp driving part 3 includes a switching transistor Tr1 as an NPN type bipolar transistor Tr1 and a switching power transistor FET1 as a P-channel type power MOSFET. The base terminal (B) of the switching transistor Tr1 is electrically connected to the control part 2 through a resistance R1 to receive the lamp driving control signal S11. Further, a conductor which connects the base terminal (B) of the switching transistor Tr1 and the resistance R1 is electrically connected to a ground (G) through a resistance R2. Further, the emitter terminal (E) of the switching transistor Tr1 is electrically connected to the ground (G).

The gate terminal (G) of the switching power transistor FET1 is electrically connected to the collector terminal (C) of the switching transistor Tr1 through a resistance R3. A drain terminal (D) of the switching power transistor FET1 is electrically connected to the lamp driving power supply line 4. A source terminal (S) of the switching power transistor FET1 is electrically connected to the lamp driving line 5.

A resistance R4 and a Zener diode D1 are connected in parallel with the gate terminal (G) and the drain terminal (D) of the switching power transistor FET1. The resistance R4, the Zener diode D1 and the resistance R3 supply electric current which flows from the collector terminal (C) of the switching transistor Tr1 to the emitter terminal (E) from the lamp driving power supply line 4 when the lamp driving control signal S11 of high level is supplied to the base terminal (B) of the switching transistor Tr1 from the control part 2 to turn on the switching transistor Tr1. At this time, voltage obtained by dividing the supplied voltage Vd of the lamp driving power supply line 4 is applied to the gate terminal (G) of the switching power transistor FET1.

In the switching transistor Tr1, when the lamp driving control signal S11 applied to the base terminal (B) thereof is located in a high level, the electric current is allowed to flow from the collector terminal (C) of the switching transistor Tr1 to the emitter terminal (E). Since the electric current is allowed to flow from the lamp driving power supply line 4 through the resistance R4, the Zener diode D1 and the resistance R3, the potential of the gate terminal (G) of the switching power transistor FET1 becomes a low level to turn on the switching power transistor FET1. Accordingly, the electric current is supplied to the lamp L1 electrically connected to the ground (G) from the lamp driving power supply line 4 through the switching power transistor FET1 and the lamp driving line 5.

On the other hand, when the lamp driving control signal S11 applied to the base terminal (B) of the switching transistor Tr1 becomes a low level, the electric current does not flow between the collector terminal (C) and the emitter terminal (E) of the switching transistor Tr1. Thus, the potential of the gate terminal (G) of the switching power transistor FET1 reaches a high level (that is, supplied voltage Vd) to turn off the switching power transistor FET1 so that the electric current is not supplied to the lamp L1.

When, for instance, the switching power transistor FET1 in the above-described lamp driving apparatus 1 for a vehicle is failed due to a short mode between the drain terminal (D) and the source terminal (S), high voltage such as DC 42V is directly applied to the lamp L1, so that the filaments of the lamp L1 are fused or blown out. When the switching power transistor FET1 is brought into a failure due to the short mode, if at least the switching power transistor FET1 is not replaced by another transistor, a normal operation of the lamp driving apparatus 1 for a vehicle cannot be obtained. Therefore, even under an unexpected state such as the generation of an abnormality in a power source system or a circuit system, a redundancy or a fault tolerance that a complete failure does not arise and a function is not lost is required for the lamp driving apparatus 1 for a vehicle.

### SUMMARY OF THE INVENTION

It is therefore an object of the present invention to provide a lamp driving apparatus having a protecting function which considers a redundancy or a fault tolerance.

In order to achieve the above object, according to the present invention, there is provided a lamp driving apparatus comprising:

a controller, which outputs a switch control signal and a lamp driving control signal in response to an instructing signal for instructing a lamp to be turned on and off;

a lamp driver, which supplies an electric power to the lamp in accordance with the lamp driving control signal;

a lamp voltage detector, which detects a voltage applied to the lamp, and outputs a detecting signal showing the applied state of the voltage to the controller;

a switch, connected to the lamp driver, a lamp driving power supply line, and a preliminary power supply line, and which switches between a first state and a second state selectively;
wherein the first state is a state that the electric power for driving the lamp can be supplied to the lamp driver from the lamp driving power supply line; and
   wherein the second state is a sate that the electric power for driving the lamp can be supplied to the lamp driver from the preliminary power supply line; and

a switching controller, which controls a switching of the switch in accordance with the switch control signal,

wherein the controller outputs the switch control signal so as to make the switch to the first state when the instructing signal for instructing the lamp to be turned on; and

wherein the controller outputs the switch control signal so as to make the switch to the second state in a case that the detecting signal showing an abnormal applied state of the voltage is received from the lamp voltage detector while the controller outputs the lamp driving control signal for turning on the lump.

Preferably, the switch includes a relay which having;

a first relay contact, electrically connected to the lamp driver;

a second relay contact, electrically connected to the lamp driving power supply line;

a third relay contact, electrically connected to the preliminary power supply line;

a contact piece, electrically connecting the first relay contact to the third relay contact in an initial state; and

an electromagnetic coil, switching the contact piece so as to remove the contact piece from the third relay and so as to electrically connect the first relay contact with the second relay contact when an electric current is supplied to the electromagnetic coil; and

wherein the switching controller includes a relay driver which supply the electric current to the electromagnetic coil in accordance with the switch control signal.

Preferably, the lamp driver supplies the electric power to the lamp in accordance with a wave form of the lamp driving control signal.

Preferably, the controller outputs the lamp driving control signal having a pulse wave form in voltage when the switch is in the first state, and the controller outputs the lamp driving control signal having a DC voltage when the switch is in the second state.

Preferably, the lamp voltage detector outputs the detecting signal showing the abnormal applied state of the voltage to the controller when detecting that a DC voltage applied to the lamp is higher than a predetermined voltage.

Preferably, the lamp voltage detector outputs the detecting signal showing the abnormal applied state of the voltage to the controller when detecting that no voltage is applied to the lamp.

Here, it is preferable that, the controller compares a time length of a high level voltage of the detecting signal with that of the lamp driving control signal, and the controller outputs the switch control signal so as to make the switch to the second state on the basis of the comparing.

Here, it is preferable that, the controller compares the voltage applied to the lamp with threshold voltage data stored therein, and the controller outputs the switch control signal so as to make the switch to the second state on the basis of the comparing.

In the above configurations, when the controller receives the instructing signal for instructing the lamp to be turned on, the controller outputs the relay driving control signal for allowing the relay driving part to carry out an operation for supplying the electric current to the electromagnetic coil so that the contact piece is made to come into contact with the second relay contact by the electromagnetic coil, and then, after a state that the electric power for driving the lamp can be supplied to the lamp driver from the lamp driving power supply line through the first and second relay contacts is obtained, the controller outputs the lamp driving control signal of a pulse wave-form for allowing the lamp driver to turn on the lamp. When the controller receives the detecting signal for informing that DC voltage not lower than a prescribed voltage is applied to the lamp from the lamp applied voltage detecting part while the controller outputs the lamp driving control signal for allowing the lamp driver to turn on the lamp, the controller outputs the relay driving control signal for stopping the operation of the relay driver for supplying the electric current to the electromagnetic coil so that the contact piece is made to come into contact with the third relay contact by the electromagnetic coil and the electric power for driving the lamp is supplied to the lamp driver from the preliminary power supply line through the first and third relay contacts. Accordingly, for instance, even when the input circuit of the lamp driver to which the electric power for driving the lamp is supplied from the lamp driving power supply line of high voltage such as DC 42V and the output circuit of the lamp driver for supplying the electric power to the lamp are failed due to the short mode, a detecting signal for informing that DC voltage not lower than a prescribed voltage which is not the pulse wave-form voltage is applied to the lamp as the lamp applied voltage is supplied to the controller from the lamp applied voltage detecting part. The controller outputs the relay driving control signal in response thereto so that the electric power for driving the lamp is supplied to the lamp driver from the preliminary power supply line having voltage lower than, for instance, 14V of the lamp driving power supply line. Therefore, the lamp driving apparatus for a vehicle has a redundancy or a fault tolerance in which a complete failure does not arise and a function is not lost. Thus, even when the above-described failure is generated in the lamp driving apparatus, the lamp can be turned on. In the lamp driving apparatus, since the lamp is turned on after the first and second relay contacts are electrically conducted to each other, even when voltage applied to the lamp driving power supply line is high voltage such as 42V, an arc is not generated in the first and second relay contacts. Consequently, when the controller receives the instructing signal for instructing the lamp to be turned off, if the controller outputs the lamp driving control signal for allowing the lamp driver to performing an operation for turning off the lamp (that is, an operation for supplying no electric power to the lamp) and outputs to the relay driver the relay driving control signal for allowing the contact piece to be separated from the second relay contact and come into contact with the third relay contact by the electromagnetic coil after the supply of the electric power from the lamp driver to the lamp is interrupted, the arc is not generated in the first and second relay contacts. As described above, if, after an electric conduction between the first and second relay contacts is achieved, the lamp is turned on, and further after the lamp is turned off, the electric conduction between the first and second relay contacts is released, an expensive 42V relay in which a countermeasure for breaking the arc is provided does not need to be used and a general purpose inexpensive 14V relay can be used.

Also, in the above configurations, when the controller receives the instructing signal for instructing the lamp to be turned on, the controller outputs the relay driving control signal for allowing the relay driver to carry out an operation for supplying the electric current to the electromagnetic coil so that the contact piece is made to come into contact with the second relay contact by the electromagnetic coil, and then, after a state that the electric power for driving the lamp can be supplied to the lamp driver from the lamp driving power supply line through the first and second relay contacts is obtained, the controller outputs the lamp driving control signal for allowing the lamp driver to turn on the lamp. When the controller receives the detecting signal for informing that voltage is not applied to the lamp from the lamp applied voltage detecting part while the controller outputs the lamp driving control signal for allowing the lamp driver to turn on the lamp, the controller outputs the relay driving control signal for stopping the operation of the relay driver for supplying the electric current to the electromagnetic coil so that the contact piece is made to come into contact with the third relay contact by the electromagnetic coil and the electric power for driving the lamp is supplied to the lamp driver from the preliminary power supply line through the first and third relay contacts. Accordingly, even when the electric power for driving the lamp cannot be supplied from the lamp driving power supply line due to, for instance, the blow-out of a fuse or the like, if the controller receives a detecting signal for informing that voltage is not applied to the lamp from the lamp applied voltage detecting part while the controller outputs the lamp driving control signal for allowing the lamp driver to turn on the lamp, the controller outputs the relay driving control signal so that the electric power for driving the lamp is supplied to the lamp driver from the preliminary power supply line. Therefore, the lamp driving apparatus for a vehicle has a redundancy or a fault tolerance in which a complete failure does not arise and a function is not lost. Thus, even when the above-described failure is generated in the lamp driving apparatus for a vehicle, the lamp can be turned on. In the lamp driving apparatus for a vehicle according to the present invention, since the lamp is turned on after the first and second relay contacts are electrically conducted to each other, even when voltage applied to the lamp driving power supply line is high voltage such as 42V, an arc is not generated in the first and second relay contacts. Consequently, when the controller receives the instructing signal for instructing the lamp to be turned off, if the controller outputs the lamp driving control signal for allowing the lamp driver to performing an operation for turning off the lamp (that is, an operation for supplying no electric power to the lamp) and outputs to the relay driver the relay driving control signal for allowing the contact piece to be separated from the second relay contact and come into contact with the third relay contact by the electromagnetic coil after the supply of the electric power from the lamp driver to the lamp is interrupted, the arc is not generated in the first and second relay contacts. As described above, if, after an electric conduction between the first and second relay contacts is achieved, the lamp is turned on, and further after the lamp is turned off, the electric conduction between the first and second relay contacts is released, an expensive 42V relay in which a countermeasure for breaking the arc is provided does not need to be used and a general purpose inexpensive 14V relay can be used.

According to the present invention, there is also provided a lamp driving apparatus, comprising:

a controller, which outputs a relay driving control signal and a first lamp driving control signal in response to an instructing signal for instructing a lamp to be turned on and off;

a lamp driver, which supplies an electric power to the lamp in accordance with the first lamp driving control signal;

a relay, which includes:
a first relay contact, electrically connected to the lamp driver;
a second relay contact, electrically connected to the lamp driving power supply line for supplying an electric power to the lamp driver;
a third relay contact, electrically connected to the preliminary power supply line for supplying an electric power to the lamp driver instead of connection to the lamp driving power supply line;
a contact piece, electrically connecting the first relay contact to the third relay contact in an initial state; and
an electromagnetic coil, switching the contact piece so as to remove the contact piece from the third relay and so as to electrically connect the first relay contact with the second relay contact when an electric current is supplied to the electromagnetic coil;

a relay driver, which supplies the electric current to the electromagnetic coil in accordance with the relay driving control signal; and

a coil voltage detector, which detects a voltage applied to the electromagnetic coil, and outputs a detecting signal showing the applied state of the voltage to the controller,

wherein the controller outputs the first lamp driving control signal for controlling the lump to be turned on, after the controller outputs the relay driving control signal based on the instructing signal for instructing a lamp to be turned on so that the relay is made to a state that the electric power for driving the lamp can be supplied to the lamp driver from the lamp driving power supply line; and

wherein the controller outputs a second lamp driving control signal being different from the first lamp driving control signal in kind of a wave form in a case that the detecting signal showing that no voltage is applied to the electromagnetic coil is received from the lamp voltage detector while the controller outputs the relay driving control signal.

Preferably, the first lamp driving control signal has a pulse wave form in voltage, and the second lamp driving control signal has a DC voltage.

In the above configurations, when the controller receives the instructing signal for instructing the lamp to be turned on, the controller outputs the relay driving control signal for allowing the relay driver to carry out an operation for supplying the electric current to the electromagnetic coil so that the contact piece is made to come into contact with the second relay contact by the electromagnetic coil, and then, after a state that the electric power for driving the lamp can be supplied to the lamp driver from the lamp driving power supply line through the first and second relay contacts is obtained, the controller outputs the lamp driving control signal of a pulse voltage wave-form for allowing the lamp driver to turn on the lamp. When the controller receives the detecting signal for informing that voltage is not applied to the electromagnetic coil from the coil applied voltage detecting part while the controller outputs the relay driving control signal for allowing the relay driver to supply the electric current to the electromagnetic coil, the controller outputs the lamp driving control signal of DC voltage for allowing the lamp driver to turn on the lamp. Accordingly, even when the relay driver cannot perform an operation for supplying the electric current to the electromagnetic coil due to, for instance, the blow-out of a fuse or the like, if the controller receives a detecting signal for informing that voltage is not applied to the electromagnetic coil from the coil applied voltage detecting part while the controller outputs the relay driving control signal for allowing the relay driver to supply the electric current to the electromagnetic coil, the controller outputs the lamp driving signal of DV voltage for allowing the lamp driver to turn on the lamp. Therefore, the lamp driving apparatus for a vehicle has a redundancy or a fault tolerance in which a complete failure does not arise and a function is not lost. Thus, even when the above-described failure is generated in the lamp driving apparatus for a vehicle, the lamp can be turned on. In the lamp driving apparatus for a vehicle according to the present invention, since the lamp is turned on after the first and second relay contacts are electrically conducted to each other, even when voltage applied to the lamp driving power supply line is high voltage such as 42V, an arc is not generated in the first and second relay contacts. Consequently, when the controller receives the instructing signal for instructing the lamp to be turned off, if the controller outputs the lamp driving control signal for allowing the lamp driver to performing an operation for turning off the lamp (that is, an operation for supplying no electric power to the lamp) and outputs to the relay driver the relay driving control signal for allowing the contact piece to be separated from the second relay contact and come into contact with the third relay contact by the electromagnetic coil after the supply of the electric power from the lamp driver to the lamp is interrupted, the arc is not generated in the first and second relay contacts. As described above, if, after an electric conduction between the first and second relay contacts is achieved, the lamp is turned on, and further after the lamp is turned off, the electric conduction between the first and second relay contacts is released, an expensive 42V relay in which a countermeasure for breaking the arc is provided does not need to be used and a general purpose inexpensive 14V relay can be used.

The present invention was briefly explained as stated above. Further, embodiments of the present invention described below will be read by referring to the accompanying drawings, so that the detail of the present invention will become more apparent.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a diagram showing a structure of a circuit of a lamp driving apparatus for a vehicle according to the present invention;

FIG. 2 is a timing chart of a voltage waveform of an instructing signal, a voltage wave-form of a relay driving control signal, a voltage wave-form of a lamp driving control signal and a wave-form of lamp applied voltage shown in FIG. 1;

FIG. 3 is a timing chart of the voltage wave-forms of the signals in respective points of FIG. 1 for explaining the control operations of the lamp driving apparatus 10 for a vehicle upon failure of a switching power transistor FET1 or a switching transistor Tr1 under a short mode;

FIG. 4 is a timing chart of the voltage wave-forms of the signals in the respective points of FIG. 1 for explaining the control operation of the lamp driving apparatus 10 for a vehicle when the fuse F42 of a lamp driving power supply line 4 is blown out;

FIG. 5 is a timing chart of the voltage wave-forms of the signals in the respective points of FIG. 1 for explaining the control operation of the lamp driving apparatus 10 for a vehicle when the fuse F14 of a relay driving power supply line 9 is blown out;

FIG. 6 is a view showing a modified example of the lamp driving apparatus for a vehicle shown in FIG. 1;

FIG. 7 is a timing chart of the voltage wave-forms of signals in respective points of FIG. 6;

FIG. 8 is a view showing a structure of a circuit of a usual lamp driving apparatus for a vehicle;

FIG. 9 is a timing chart of the voltage wave-forms of an instructing signal, the voltage wave-forms of a lamp driving control signal and the wave-forms of lamp applied voltage.

### DETAILED DESCRIPTION OF THE PREFERRED EMBODIMENTS

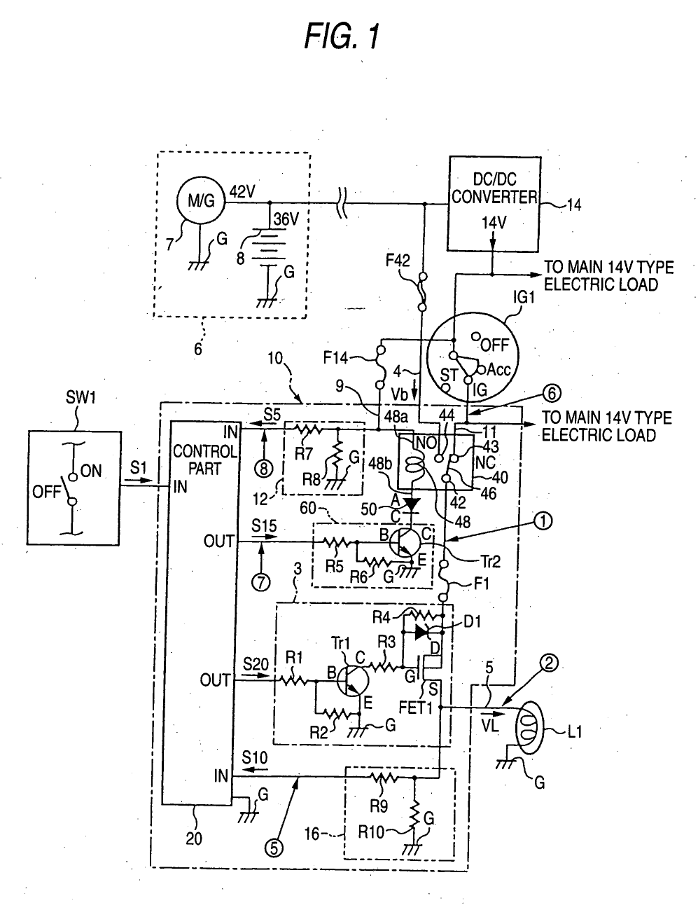

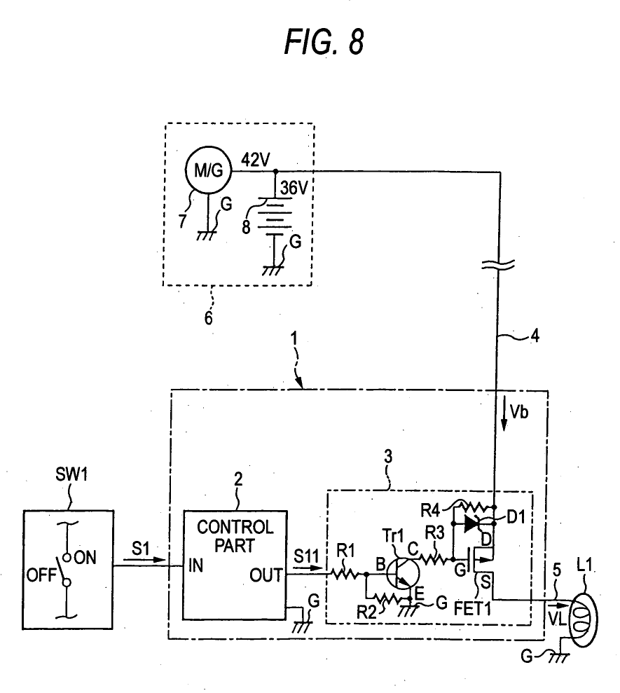

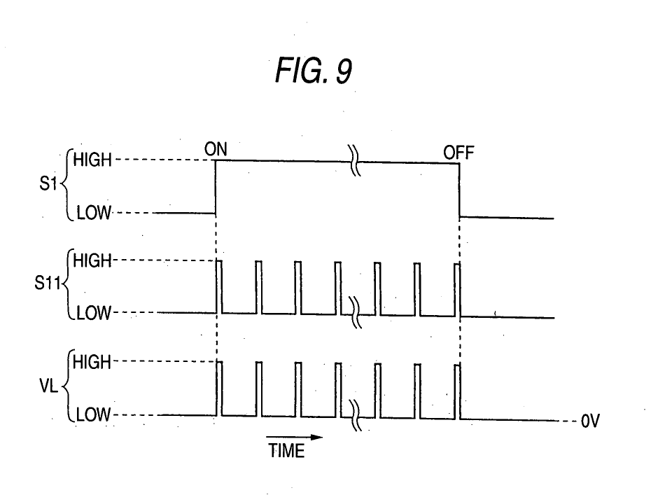

Now, preferred embodiments of the present invention will be described in detail by referring to the drawings. FIG. 1 is a view showing a circuit structure of a lamp driving apparatus 10 for a vehicle of the present invention. In this embodiment, parts capable of using the same circuits or signals as those shown in FIGS. 8 and 9 referred to for explaining the usual lamp driving apparatus 1 for a vehicle are designated by the same reference numerals to clarify them.

The lamp driving apparatus 10 for a vehicle adjusts electric energy supplied to a lamp L1 by a PWM control. The lamp driving apparatus 10 for a vehicle includes a control part 20, a lamp driving part 3, a relay 40, a diode (rectifier) 50 and a relay driving part 60.

The control part 20 outputs a relay driving control signal S15 to the relay 40 in accordance with an instructing signal S1 showing the ON/OFF state of a switch SW1 for instructing the lamp L1 to be turned on and off and also outputs a lamp driving control signal S20 to the lamp driving part 3 to control the operation of the relay 40 and the operation of the lamp driving part 3. The control part 20 can be composed of a semiconductor integrated circuit such as a CPU and incorporates a processing circuit for outputting the relay driving control signal S15 and the lamp driving control signal S20 based on the input of the instructing signal S1. The lamp driving part 3 is electrically connected to the control part 20 to supply electric power to the lamp L1 in accordance with the lamp driving control signal S20 supplied from the control part 20.

The relay 40 includes a first relay contact 42, a second relay contact 44, a third relay contact 43, a contact arm 46 and an electromagnetic coil. The first relay contact 42 is electrically connected to the lamp driving part 3. The second relay contact 44 is electrically connected to a lamp driving power supply line 4 for supplying electric power to the lamp driving part 3. The third relay contact 43 is electrically connected to a preliminary power supply line 11 for supplying the electric power to the lamp driving part 3 in place of the lamp driving power supply line 4. The contact arm 46 is electrically connected to the first relay contact 42 and comes into contact with the third relay contact 43 to make the first and third relay contacts 42 and 43 conduct to each other. The electromagnetic coil allows the contact arm 46 so as to be separated from the third relay contact 43 and come into contact with the second relay contact 44 so that the second relay contact 44 is conduct to the first relay contact 42.

When the relay 40 is not driven, the first and third relay contacts 42 and 43 are located in a short state (that is, a conducted state) and the first and second relay contacts 42 and 44 are located in an open state (that is, a non-conducted state). In other words, the relay 40 is what is called a transfer type relay that the first and third relay contacts 42 and 43 are respectively normally close (NC) contact type, and the first and second relay contacts 42 and 44 are respectively normally open (NO) contact type.

The lamp driving part 3 receives the supply of electric power from a power source part 6 of rated DC 36 V to 42 V output through the lamp driving power supply line 4 to drive the lamp L1 when the first and second relay contacts 42 and 44 of the relay 40 are located in the short state (that is, a conducted state). The power source part 6 includes a 42V motor/generator 7 and a 36V battery 8 capable of charging and discharging. Supplied voltage Vb applied to the lamp driving power supply line 4 is DC 36V to DC 42V in accordance with the rated output voltage of the power source part 6. A fuse F42 for protecting an over-current is inserted into the lamp driving power supply line 4. A fuse F1 for protecting an over-current is inserted into a conductor for connecting the first relay contact 42 to the lamp driving part 3.

One end 48a of an electromagnetic coil 48 of the relay 40 is electrically connected to a relay driving power supply line 9 to receive the supply of an electric current from the relay driving power supply line 9. The relay driving power supply line 9 is electrically connected to the output of a DC voltage converter (that is, a DC/DC converter) 14 for converting the output voltage of the power source part 6 into DC 14V. As shown in FIG. 1, the DC voltage converter 14 is provided mainly for the purpose of supplying an electric power to a main 14V type electric load (that is, an electrical device). Further, a fuse F14 for protecting an over-current is inserted into the relay driving power supply line 9.

A diode 50 serving as a rectifier has its anode terminal (A) electrically connected to the other end 48b of the electromagnetic coil 48 to regulate the flow of electric current so that the electric current flows only in one direction from the relay driving power supply line 9 to the electromagnetic coil 48. A rectifier for regulating the flow of electric current so that the electric current flows only in one direction from the relay driving power supply line 9 to the electromagnetic coil 48 may be used in place of the diode 50.

The relay driving part 60 is electrically connected to the cathode terminal (C) of the diode 50 to supply an electric current to the electromagnetic coil 48 from the relay driving power supply line 9 in accordance with the relay driving control signal S15. In this connection, a configuration that the cathode terminal (C) of the diode 50 is electrically connected to one end 48a of the electromagnetic coil 48 and the anode terminal (A) is electrically connected to the relay driving power supply line 9 may be used. In this case, the relay driving part 60 is electrically connected to the other end 48b of the electromagnetic coil 48.

The relay driving part 60 is provided with a relay driving transistor Tr2 as an NPN type bipolar transistor. The base terminal (B) of the relay driving transistor Tr2 is electrically connected to the control part 20 through a resistance R5 to receive the relay driving control signal S15. Further, a conductor for connecting the base terminal (B) of the relay driving transistor Tr2 to the resistance R5 is electrically connected to a ground (G) through a resistance R6. An emitter terminal (E) of the relay driving transistor Tr2 is electrically connected to the ground (G). A collector terminal (C) is electrically connected to the cathode terminal (C) of the diode 50.

The lamp driving part 3 is electrically connected to the control part 20, the lamp driving power supply line 4 and a lamp driving line 5 to apply voltage and apply no voltage to the lamp L1 through the lamp driving line 5 in accordance with the lamp driving control signal S20 so that the lamp L1 is turned on and off. Since the circuit structure of the lamp driving part 3 has been already described by referring to FIG. 8, its explanation will be omitted. In this embodiment, although the NPN type bipolar transistor is used as one example of a switching transistor Tr1, other transistors such as a PNP type bipolar transistor, an MOSFET, etc. may be properly employed. Further, the phase of the lamp driving control signal S20 may be suitably inverted in accordance with the type of the switching transistor Tr1 to be used. Further, in this embodiment, although a P channel type power MOSFET is employed as one example of a switching power transistor FET1, other transistors such as an N channel type power MOSFET, a bipolar transistor, etc. may be properly employed. Further, the phase of the lamp driving control signal S20 may be suitably inverted in accordance with the type of the switching power transistor FET1 to be used.

In the lamp driving apparatus 10 for a vehicle constructed as mentioned above, when the control part 20 receives the instructing signal S1 for instructing the lamp L1 to be turned on, the control part 20 outputs the relay driving control signal S15 for allowing the relay driving part 60 to supply an electric current to the electromagnetic coil 48 of the relay 40 from the relay driving power supply line 9, so that the electromagnetic coil 48 allows the contact arm 46 of the relay 40 to be separated from the third relay contact 43 and come into contact with the second relay contact 44 to make the second relay contact conduct to the first relay contact 42. Accordingly, an electric power for driving the lamp L1 can be supplied to the lamp driving part 3 from the lamp driving power supply line 4 through the first and second relay contacts 42 and 44.

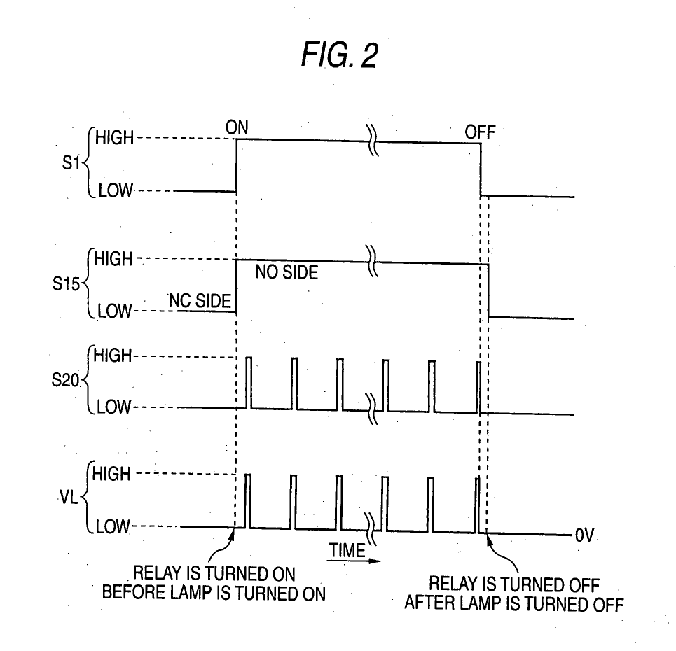

FIG. 2 is a timing chart showing the voltage wave-form of the instructing signal S1, the voltage wave-form of the relay driving control signal S15, the voltage wave-form of the lamp driving control signal S20, and the wave-form of lamp applied voltage VL applied to the lamp L1 by the lamp driving part 3.

As shown in FIG. 2, the control part 20 outputs the relay driving control signal S15 having the voltage wave-form that the voltage wave-form is switched from a low level to a high level synchronously with a timing that the voltage wave-form of the instructing signal S1 is changed from a low level to a high level. The instructing signal S1 at this time instructs the lamp L1 to be turned on.

When the base terminal (B) of the relay driving transistor Tr2 of the relay driving part 60 receives the relay driving control signal S15 of high level through the resistance R5, a state that an electric current is allowed to flow from the collector terminal (C) of the relay driving transistor Tr2 to the emitter terminal (E) is established so that the electric current flows to the electromagnetic coil 48 of the relay 40 from the relay driving power supply line 9. At this time, the contact arm 46 is attracted to the electromagnetic coil 48 by an electromagnetic force so that the first and second relay contacts 42 and 44 are brought into a short state. Accordingly, an electric power for driving the lamp L1 can be supplied to the lamp driving part 3 from the lamp driving power supply line 4.

The control part 20 outputs the lamp driving control signal S20 for allowing the lamp driving part 3 to perform an operation for turning on the lamp L1 (that is, an operation for supplying electric power to the lamp L1) after the state that the electric power for driving the lamp L1 can be supplied to the lamp driving part 3 from the lamp driving power supply line 4 is obtained. That is, as shown in FIG. 2, a rise timing that the voltage wave-form of the lamp driving control signal S20 is switched from the low level to the high level is slightly delayed from both a rise timing that the voltage wave-form of the instructing signal S1 and the voltage wave-form of the relay driving control signal S15 are switched from the low level to the high level. This lamp driving control signal 20 has a pulse voltage wave-form that the high level and the low level are alternately repeated. The lamp driving part 3 applies the lamp applied voltage VL to the lamp L1 in accordance with the lamp driving control signal S20 to turn on the lamp L1. As for the lamp driving signal S20 and the lamp applied voltage VL upon turning on the lamp L1, a prescribed duty ratio is set to the pulse width of high level in one period so that a proper electric power is supplied to the lamp L1.

On the other hand, as shown in FIG. 2, the control part 20 outputs the lamp driving control signal S20 for allowing the lamp driving part 3 to perform an operation for turning off the lamp L1 (that is, an operation for supplying no electric power to the lamp L1) synchronously with a timing that the voltage wave-form of the instructing signal S1 is switched from the high level to the low level. The instructing signal S1 instructs the lamp L1 to be turned off.

When the lamp driving control signal S20 applied to the base terminal (B) of the switching transistor Tr1 becomes a low level, an electric current does not flow between the collector terminal (C) and the emitter terminal (E) of the switching transistor Tr1. Thus, the potential of the gate terminal (G) of the switching power transistor FET1 becomes a high level (that is, supplied voltage Vb), so that the switching power transistor FET1 is brought into an OFF state and the supply of electric power to the Lamp L1 from the lamp driving part 3 is interrupted.

After the supply of electric power to the lamp L1 from the lamp driving part 3 is interrupted, the control part 20 outputs to the relay driving part 60 the relay driving control signal S15 for allowing the contact arm 46 to open between the first and second relay contacts 42 and 44. That is, after the voltage wave-form of the lamp driving control signal S20 and the wave-form of the lamp applied voltage VL are switched from a high level to a low level, the control part 20 outputs the relay driving control signal S15 having the wave-form changing from a high level to a low level. As shown in FIG. 2, a fall timing that the voltage wave-form of the relay driving control signal S15 is switched from the high level to the low level is slightly delayed relative to a fall timing that the voltage wave-form of the lamp driving control signal S20 and the wave-form of the lamp applied voltage VL are switched from the high level to the low level.

When the relay driving control signal S15 applied to the base terminal (B) of the relay driving transistor Tr2 of the relay driving part 60 becomes a low level, an electric current does not flow between the collector terminal (C) and the emitter terminal (E) of the relay driving transistor Tr2 so that the electric current does not flow to the electromagnetic coil 48 of the relay 40 from the relay driving power supply line 9. Accordingly, the contact arm 46 attracted by the electromagnetic force of the electromagnetic coil 48 is separated from the second relay contact 44 to come into contact with the third relay contact 43. Consequently, the electric power for driving the lamp L1 is not supplied to the lamp driving part 3 from the lamp driving power supply line 4. Only when an ignition switch IG1 is located at an IG position or an Acc position, the electric power for driving the lamp L1 can be supplied to the lamp driving part 3 from the preliminary power supply line 11 through the third and first relay contacts 43 and 42.

Accordingly, the lamp driving apparatus 10 for a vehicle allows the contact arm 46 to locate the first and second relay contacts 42 and 44 of the relay 40 in a short state before the lamp L1 is turned on, and to locate the first and second relay contacts 42 and 44 of the relay 40 in an open state after the lamp L1 is turned off. In other words, the lamp driving apparatus 10 for a vehicle allows the lamp L1 to be turned on after the first and second relay contacts 42 and 44 are conducted to each other and releases the electric conduction between the first and second relay contacts 42 and 44 after the lamp L1 is turned off. Therefore, even when voltage applied to the lamp driving power supply line 4 is high voltage such as 42V, an arc is not generated in the first and second relay contacts 42 and 44, so that an expensive 42V relay provided with a countermeasure for breaking the arc does not required to be used. A general purpose inexpensive 14V relay can be used. A quantity of electric current supplied to the first and second relay contacts 42 and 44 is reduced since the PWM control is employed.

The lamp driving apparatus 10 for a vehicle further includes a coil applied voltage detecting part 12 and a lamp applied voltage detecting part 16. The coil applied voltage detecting part 12 detects voltage applied to the electromagnetic coil 48 and informs the control part 20 of a coil applied voltage detecting signal S5 showing the applied state of the voltage. The lamp applied voltage detecting part 16 detects lamp applied voltage VL applied to the lamp L1 by the lamp driving part 3 to inform the control part 20 of a lamp applied voltage detecting signal S10 showing the applied state f the lamp applied voltage VL.

The coil applied voltage detecting part 12 includes a resistance R7 and a resistance R8. The control part 20 is electrically connected to the electromagnetic coil 48 through the resistance R7 for obtaining the coil applied voltage detecting signal S5. A conductor for connecting the resistance R7 to the electromagnetic coil 48 is electrically connected to a ground (G) through the resistance R8. The lamp applied voltage detecting part 16 includes a resistance R9 and a resistance R10. The control part 20 is electrically connected to the source terminal (S) of the switching power transistor FET1 of the lamp driving part 3 and the input terminal of the lamp L1 through the resistance R9 so as to obtain the lamp applied voltage detecting signal S10. A conductor for connecting the resistance R9, the source terminal (S) and the input terminal of the lamp L1 is electrically connected to a ground (G) through the resistance R10.

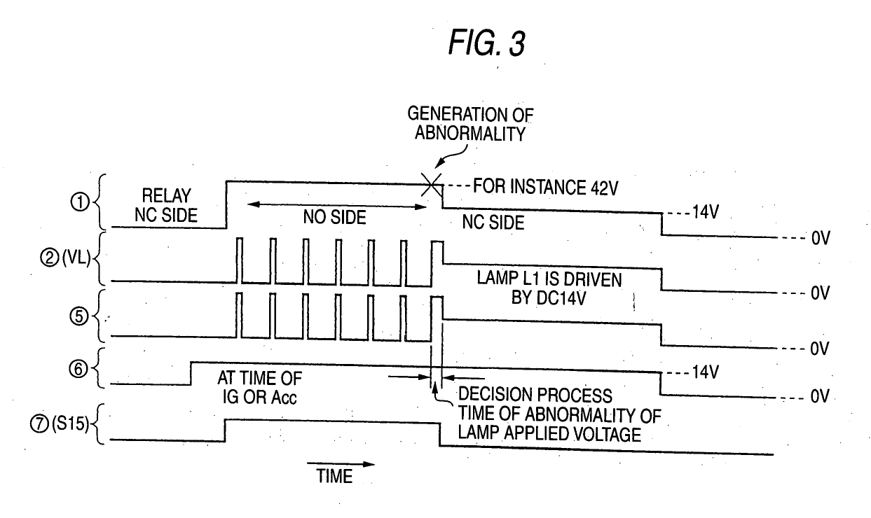

As described above, the lamp driving apparatus 10 for a vehicle includes the coil applied voltage detecting part 12 and the lamp applied voltage detecting part 16. Even when the lamp L1 is, for instance, a head lamp, a turn lamp, a stop lamp, etc. which are important for moving a vehicle and the failure of the lamp driving apparatus 10 for a vehicle is generated during driving the vehicle, the lamp driving apparatus 10 for a vehicle can turn on the lamp L1. Now, the redundancy or the fault tolerance of the lamp driving apparatus 10 for a vehicle in which a complete failure does not arise and a function is not lost will be described below (see FIGS. 3, 4 and 5).

For example, even when the switching power transistor FET1 of the lamp driving part 3 is failed due to the short between a drain terminal (D) and a source terminal (S) or the switching transistor Tr1 is failed due to the short between the collector terminal (C) and the emitter terminal (E), the lamp driving apparatus 10 for a vehicle is provided with the redundancy or the fault tolerance in which the complete failure of the apparatus does not arise and the function of the apparatus is not lost.

Specifically, in a case that the control part 20 receives the lamp applied voltage detecting signal S10 for informing that prescribed DC voltage is applied to the lamp L1 from the lamp applied voltage detecting part 16 while the control part 20 outputs the lamp driving control signal S20 for allowing the lamp driving part 3 to turn on the lamp L₁, the control part 20 outputs the relay driving control signal S15 for stopping the operation of the relay driving part 60 for supplying an electric current to the electromagnetic coil 48. Thus, the contact arm 46 is brought into contact with the third relay contact 43 by the electromagnetic coil 48, and an electric power for driving the lamp L1 is supplied to the lamp driving part 3 from the preliminary power supply line 11 through the first and third relay contacts 42 and 44.

That is, the lamp applied voltage detecting signal S10 for informing that the prescribed DC voltage which is not a pulse wave-form voltage is applied to the lamp L1 as the lamp applied voltage VL is supplied to the control part 20 from the lamp applied voltage detecting part 16. The control part 20 outputs the relay driving control signal S15 in accordance therewith so that an electric power for driving the lamp L1 is supplied to the lamp driving part 3 from the preliminary power supply line 11 having voltage lower than that of the lamp driving power supply line 4. The control part 20 compares the time length of the high level voltage of the lamp applied voltage detecting signal S10 with the time length of the high level voltage of the lamp driving control signal S20 to decide whether or not the DC voltage having constant voltage which is not the pulse wave-form voltage is applied to the lamp L1 as the lamp applied voltage VL. Further, in the control part 20, threshold voltage (data) for deciding whether or not the lamp applied voltage VL at the a high level is the prescribed voltage or higher is stored. The control part 20 monitors the lamp applied voltage VL on the basis of the applied voltage detecting signal S10 to compare the voltage of the lamp applied voltage detecting signal S10 with the threshold voltage. As a further example of such a control operation of the control part 20, when the control part 20 receives from the lamp applied voltage detecting part 16 the lamp applied voltage detecting signal S10 for informing that the DC voltage not lower than prescribed voltage is applied to the Lamp L1 while the control part 20 outputs the lamp driving control signal S20 for allowing the lamp driving part 3 to turn on the lamp L1, the control part 20 outputs the relay driving control signal S15 for preventing the relay driving part 60 from supplying an electric current to the electromagnetic coil 48. That is, the lamp applied voltage detecting signal S10 for informing that, for instance, the prescribed DC voltage such as, not 14V but 42V is applied to the lamp L1 as the lamp applied voltage VL is supplied to the control part 20 from the lamp applied voltage detecting part 16. In response thereto, the control part 20 outputs the relay driving control signal S15 so that an electric power for driving the lamp L1 is supplied to the lamp driving part 3 from the preliminary power supply line 11 having voltage lower than that of the lamp driving power supply line 4

The control operations of the lamp driving apparatus 10 for a vehicle upon failure of the switching power transistor FET1 or the switching transistor Tr1 due to the short are apparent from a timing chart shown in FIG. 3 with the voltage wave-forms of the signals at the respective points of FIG. 1.

Further, the lamp driving apparatus 10 for a vehicle includes the redundancy or the fault tolerance in which the apparatus is not completely failed, and the function of the apparatus is not lost even when the fuse F42 of the lamp driving power supply line 4 is blown out. Specifically, when the control part 20 receives from the lamp applied voltage detecting part 16 the lamp applied voltage detecting signal S10 for informing that voltage is not applied to the lamp L1 while the control part 20 outputs the lamp driving control signal S20 for allowing the lamp driving part 3 to turn on the lamp L1, the control part 20 outputs the relay driving control signal S15 for preventing the relay driving part 60 from supplying an electric current to the electromagnetic coil 48. Thus, the contact arm 46 is brought into contact with the third relay contact 43 by the electromagnetic coil 48 and the electric power for driving the lamp is supplied to the lamp driving part 3 from the preliminary power supply line 11 through the first and third relay contacts 42 and 43.

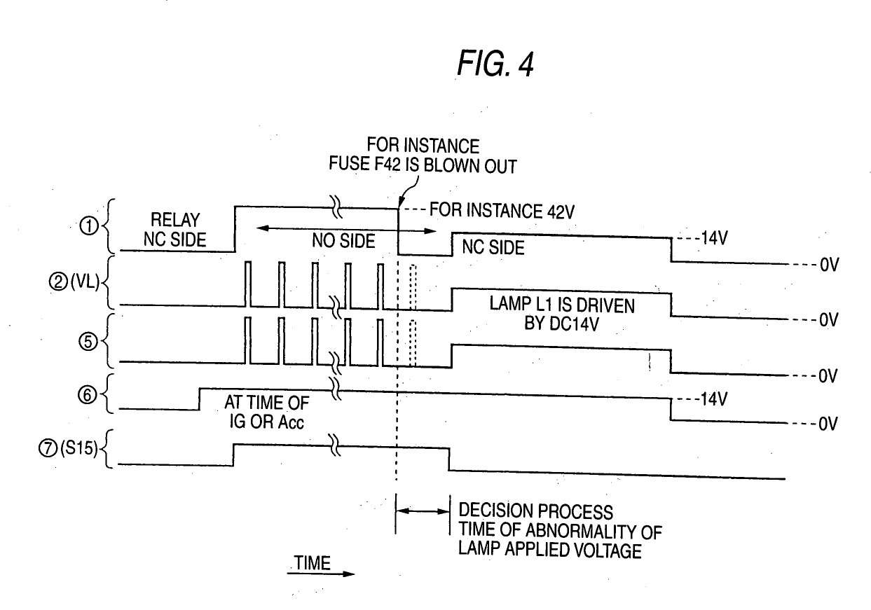

That is, even if an electric power for driving the lamp L1 cannot be supplied from the lamp driving power supply line 4, when the control part 20 receives from the lamp applied voltage detecting part 16 the lamp applied voltage detecting signal S10 for informing that voltage is not applied to the lamp L1 while the control part 20 outputs the lamp driving control signal S20 for allowing the lamp driving part 3 to turn on the lamp L1, the control part 20 outputs the relay driving control signal S15 so that the electric power for driving the lamp L1 is supplied to the lamp driving part 3 from the preliminary power supply line 11. The control operation of the lamp driving apparatus 10 for a vehicle in a case that the fuse F42 of the lamp driving power supply line 4 is blown out is apparently shown in a timing chart shown in FIG. 4 with the voltage wave-forms of the signals in the respective points of FIG. 1.

Further, the lamp driving apparatus 10 for a vehicle is provided with the redundancy or the fault tolerance that the apparatus is not completely failed and the function of the apparatus is not lost even when for instance, the fuse F14 of the relay driving power supply line 9 is blown out. Specifically, when the control part 20 receives from the coil applied voltage detecting part 12 the coil applied voltage detecting signal S5 for informing that voltage is not applied to the electromagnetic coil 48 while the control part 20 outputs the relay driving control signal S15 for allowing the relay driving part 60 to supply an electric current to the electromagnetic coil 48, the control part 20 outputs the lamp driving control signal S20 of DC voltage for allowing the lamp driving part 3 to turn on the lamp L1.

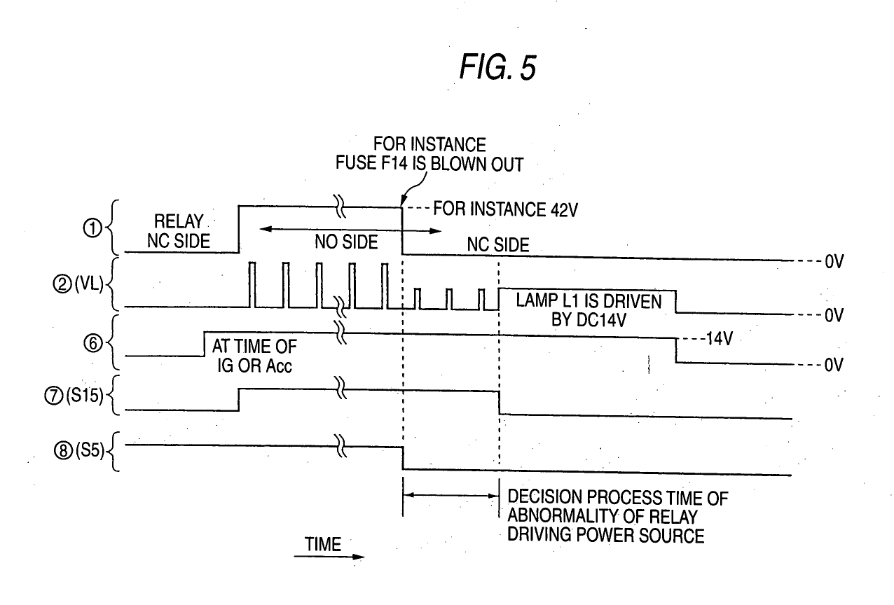

That is, even if the control part cannot allow the relay driving part 60 to supply the electric current to the electromagnetic coil 48, when the control part 20 receives from the coil applied voltage detecting part 12 the coil applied voltage detecting signal S5 for informing that voltage is not applied to the electromagnetic coil 48 while the control part 20 outputs the relay driving control signal for allowing the relay driving part 60 to supply an electric current to the electromagnetic coil 48, the control part 20 outputs the lamp driving control signal S20 of DC voltage for allowing the lamp driving part 3 to turn on the lamp L1. The control operation of the lamp driving apparatus 10 for a vehicle when the fuse F14 of the relay driving power supply line 9 is blown out is apparent from a timing chart shown in FIG. 5 with the voltage wave-forms of the signals in the respective points of FIG. 1.

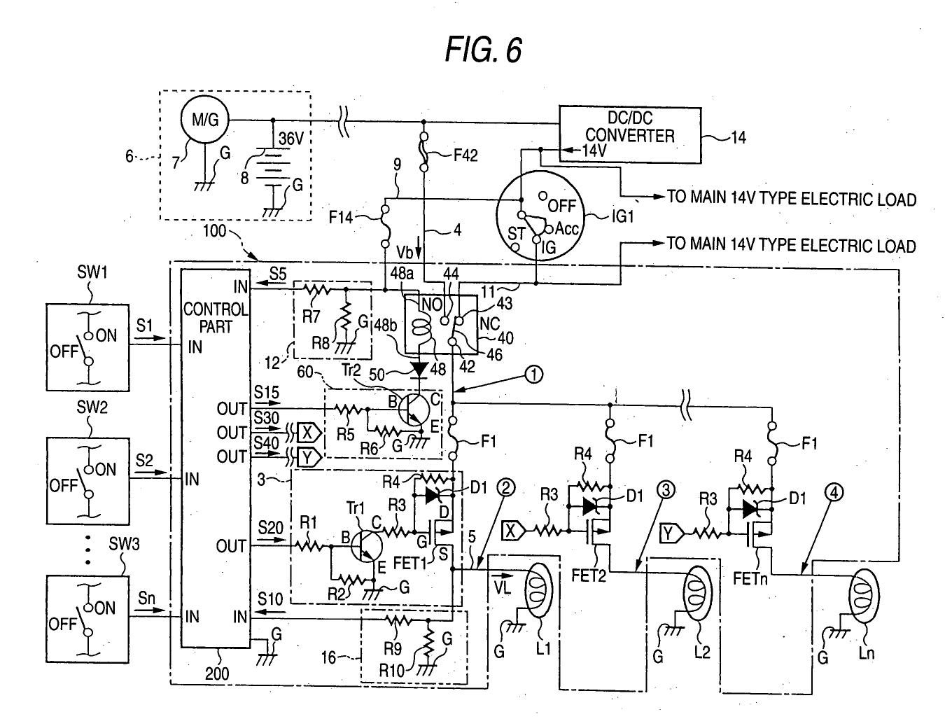

In the above-described embodiment, although one lamp L1 is assigned to one relay 40, a plurality of lamps (for instance, a head lamp, a turn lamp, a stop lamp, etc.) which are considered to be important lighting member in the vehicle may be assigned to one relay 40. When a plurality of lamps are assigned to one relay 40 as described above, a cost can be reduced, because a plurality of relays 40 do not need to be provided. The above-described lamp driving apparatus for a vehicle will be described by referring to FIG. 6.

FIG. 6 shows a second embodiment of the lamp driving apparatus 10 for a vehicle shown in FIG. 1. A lamp driving apparatus 100 for a vehicle in which the plural lamps L1, L2, . . . , Ln are assigned to one relay 40 is shown in FIG. 6. Parts which can use the same circuits or signals as those shown in FIGS. 1 and 2 referred to for explaining the above-described lamp driving apparatus 10 for a vehicle are designated by the same reference numerals to make them clear.

A control part 200 outputs a relay driving control signal S15 to the relay 40 and lamp driving control signals S20, S30, S40 respectively to a plurality of lamp driving circuits 3 in accordance with instructing signals S1, S2 . . . ,Sn showing the ON/OFF states of switches SW1, SW2 . . . , SWn respectively for instructing the lamps L1, L2,Ln to be turned on and off to control the operation of the relay 40 and the operations of the lamp driving circuits 3. A plurality of lamp driving circuits 3 are respectively electrically connected to a control part 200 to supply electric power to the lamps L1, L2 . . . ,Ln in accordance with the lamp driving control signals S20, S30, S40 supplied from the control part 200. To the first relay contact 42 of the relay 40, a plurality of lamp driving parts 3 (note: In FIG. 6, the illustration of the lamp driving parts 3 for the lamps L2 and Ln is simplified) are electrically connected.

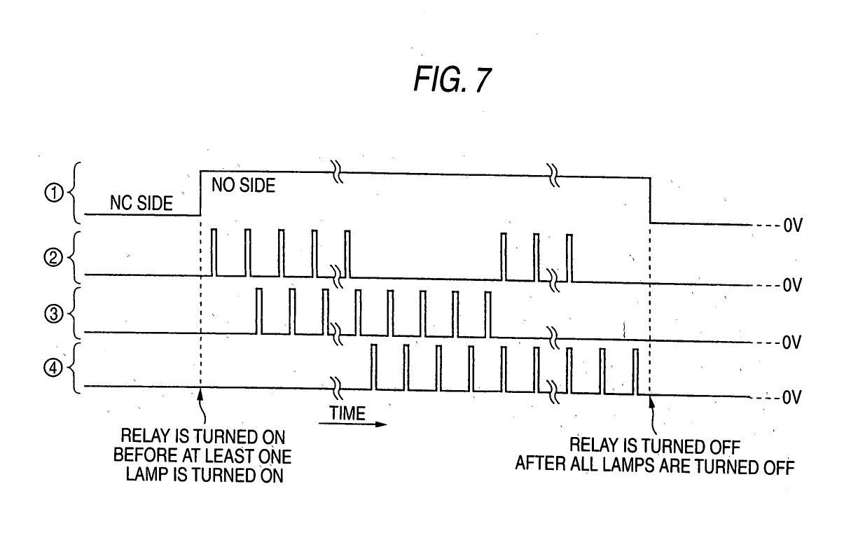

FIG. 7 shows a timing chart of voltage wave-forms of the signals at the respective points of FIG. 6. As shown in FIG. 7, the driving apparatus 100 for a vehicle allows the first and second relay contacts of the relay 40 to be located in a short state before at least one of the lamps L1, L2, . . . ,Ln is turned on, and after all the lamps L1, L2, . . . ,Ln are turned off, the apparatus allows the first and second relay contacts 42 and 44 of the relay 40 to be located in an open state. Since other circuit structures, the operations of the circuit or the like of the lamp driving apparatus 100 for a vehicle are readily estimated from the already described contents by referring to FIGS. 1 to 5, the description thereof will be omitted.

The present invention is not limited to the above-described embodiment or the modified example, modifications, improvements, or the like may be suitably made. Further, when the present invention can be achieved, any number of respective components, any places where they are arranged, etc. in the above-described embodiment and the modified example, and any wave-forms, any numeric values, etc. may be used and they are not limitative.

The above-described wave-forms of the signals are not limited to rectangular waves as shown in FIGS. 2 to 5 and 7, for instance, a triangular wave, a serrated wave, etc. may be suitably used. Further, in the above-described embodiment, although the instructing signal having a voltage wave-form formed by the potential difference between the high level and the low level is used, for instance, several kinds of logic signals may be respectively inputted to the control part to deduce the ON/OFF states of the switches on the basis of these logic signals by the control part and properly form the relay driving control signal and the lamp driving control signal.

What is claimed is:

1. A lamp driving apparatus, comprising:
a controller, which outputs a switch control signal and a lamp driving control signal in response to an instructing signal for instructing a lamp to be turned on and off;
a lamp driver, which supplies an electric power to the lamp in accordance with the lamp driving control signal;
a lamp voltage detector, which detects a voltage applied to the lamp, and outputs a detecting signal showing the applied state of the voltage to the controller;
a switch, connected to the lamp driver, a lamp driving power supply line, and a preliminary power supply line, and which switches between a first state and a second state selectively;
wherein the first state is a state that the electric power for driving the lamp can be supplied to the lamp driver from the lamp driving power supply line; and
wherein the second state is a sate that the electric power for driving the lamp can be supplied to the lamp driver from the preliminary power supply line; and
a switching controller, which controls a switching of the switch in accordance with the switch control signal,
wherein the controller outputs the switch control signal so as to make the switch to the first state when the instructing signal for instructing the lamp to be turned on; and
wherein the controller outputs the switch control signal so as to make the switch to the second state in a case that the detecting signal showing an abnormal applied state of the voltage is received from the lamp voltage detector while the controller outputs the lamp driving control signal for turning on the lump.

2. The lamp driving apparatus as set forth in claim 1, wherein the switch includes a relay which having;
a first relay contact, electrically connected to the lamp driver;
a second relay contact, electrically connected to the lamp driving power supply line;
a third relay contact, electrically connected to the preliminary power supply line;
a contact piece, electrically connecting the first relay contact to the third relay contact in an initial state; and
an electromagnetic coil, switching the contact piece so as to remove the contact piece from the third relay and so as to electrically connect the first relay contact with the second relay contact when an electric current is supplied to the electromagnetic coil; and
wherein the switching controller includes a relay driver which supply the electric current to the electromagnetic coil in accordance with the switch control signal.

3. The lamp driving apparatus as set forth in claim 1, wherein the lamp driver supplies the electric power to the lamp in accordance with a wave form of the lamp driving control signal.

4. The lamp driving apparatus as set forth in claim 1, wherein the controller outputs the lamp driving control signal having a pulse wave form in voltage when the switch is in the first state; and
wherein the controller outputs the lamp driving control signal having a DC voltage when the switch is in the second state.

5. The lamp driving apparatus as set forth in claim 1, wherein the lamp voltage detector outputs the detecting signal showing the abnormal applied state of the voltage to the controller when detecting that a DC voltage applied to the lamp is higher than a predetermined voltage.

6. The lamp driving apparatus as set forth in claim 1, wherein the lamp voltage detector outputs the detecting signal showing the abnormal applied state of the voltage to the controller when detecting that no voltage is applied to the lamp.

7. The lamp driving apparatus as set forth in claim 5, wherein the controller compares a time length of a high level voltage of the detecting signal with that of the lamp driving control signal; and
wherein the controller outputs the switch control signal so as to make the switch to the second state on the basis of the comparing.

8. The lamp driving apparatus as set forth in claim 6, wherein the controller compares the voltage applied to the lamp with threshold voltage data stored therein; and
wherein the controller outputs the switch control signal so as to make the switch to the second state on the basis of the comparing.

9. A lamp driving apparatus, comprising:
a controller, which outputs a relay driving control signal and a first lamp driving control signal in response to an instructing signal for instructing a lamp to be turned on and off;
a lamp driver, which supplies an electric power to the lamp in accordance with the first lamp driving control signal;
a relay, which includes:
a first relay contact, electrically connected to the lamp driver;
a second relay contact, electrically connected to the lamp driving power supply line for supplying an electric power to the lamp driver;
a third relay contact, electrically connected to the preliminary power supply line for supplying an electric power to the lamp driver instead of connection to the lamp driving power supply line;
a contact piece, electrically connecting the first relay contact to the third relay contact in an initial state; and
an electromagnetic coil, switching the contact piece so as to remove the contact piece from the third relay and so as to electrically connect the first relay contact with the second relay contact when an electric current is supplied to the electromagnetic coil;
a relay driver, which supplies the electric current to the electromagnetic coil in accordance with the relay driving control signal; and
a coil voltage detector, which detects a voltage applied to the electromagnetic coil, and outputs a detecting signal showing the applied state of the voltage to the controller,
wherein the controller outputs the first lamp driving control signal for controlling the lump to be turned on, after the controller outputs the relay driving control signal based on the instructing signal for instructing a lamp to be turned on so that the relay is made to a state that the electric power for driving the lamp can be supplied to the lamp driver from the lamp driving power supply line; and
wherein the controller outputs a second lamp driving control signal being different from the first lamp driving control signal in kind of a wave form in a case that the detecting signal showing that no voltage is applied to the electromagnetic coil is received from the lamp voltage detector while the controller outputs the relay driving control signal.

10. The lamp driving apparatus as set forth in claim 9, wherein the first lamp driving control signal has a pulse wave form in voltage; and
wherein the second lamp driving control signal has a DC voltage.
